(19) United States
(12) Patent Application Publication
(10) Pub. No.: US 2026/0309968 A1
(43) Pub. Date: Oct. 8, 2026

(54) IMMERSION SYSTEM, MICROSCOPE AND METHOD FOR CONTROLLING AN IMMERSION SYSTEM

(71) Applicant: Leica Microsystems CMS GmbH, Wetzlar (DE)

(72) Inventor: Zoran SUBOTIC, Wetzlar (DE)

(21) Appl. No.: 19/636,950

(22) Filed: Apr. 2, 2026

(30) Foreign Application Priority Data
Apr. 7, 2025 (DE) 102025113525.8

(51) Int. Cl. G02B 21/33; G02B 21/00; G02B 21/26

(52) U.S. Cl. CPC G02B 21/33; G02B 21/0088; G02B 21/26

(57) ABSTRACT

An immersion system for a microscope includes a reservoir for an immersion liquid, a pump system, a z-drive, an x-y-drive, and a control unit. The pump system moves the immersion liquid from the reservoir to a target space between a front lens of an objective of the microscope and a sample arranged on a stage of the microscope to create an immersion droplet. The z-drive moves the objective and/or the stage along a z-direction in order to adjust a distance between the front lens and the sample in the z-direction. The x-y-drive moves the objective and/or the stage perpendicular to the z-direction in order to adjust a relative position of the front lens and the sample in x-y-directions. The control unit is configured to control the pump system, z-drive, and x-y-drive, to perform a droplet replacement procedure, and to initiate the droplet replacement procedure based on an initiation signal.

### CROSS REFERENCE TO RELATED APPLICATIONS

This application claims benefit to German Patent Application No. 102025113525.8, filed on Apr. 7, 2025, which is hereby incorporated by reference herein.

### FIELD

The invention relates to an immersion system for a microscope, a microscope, and a method for controlling an immersion system.

### BACKGROUND

Immersion in microscopy involves placing an immersion liquid, typically oil or water, in a target space between a front lens of an objective of a microscope and a sample. The immersion liquid reduces light refraction at the interface, thereby increasing the effective numerical aperture of the objective. This results in improved resolving power, particularly at high magnifications. However, air bubbles may form in the immersion liquid, for example when the immersion liquid is applied. Light is refracted by these air bubbles, causing blurring in the image generated by the microscope. Especially for an inexperienced user, it can be difficult to associate this blurring with air bubbles in the immersion liquid. Even if the origin of the blurring is correctly identified by the user, solving the problem requires removing the sample from the microscope and reapplying the immersion liquid, which is time consuming.

### SUMMARY

In an embodiment, the present disclosure provides an immersion system for a microscope that includes a reservoir for an immersion liquid, a pump system, a z-drive, an x-y-drive, and a control unit. The pump system is configured to move the immersion liquid from the reservoir to a target space between a front lens of an objective of the microscope and a sample arranged on a stage of the microscope to create an immersion droplet. The z-drive is configured to move the objective and/or the stage along a z-direction in order to adjust a distance between the front lens and the sample in the z-direction. The x-y-drive is configured to move the objective and/or the stage perpendicular to the z-direction in order to adjust a relative position of the front lens and the sample in x-y-directions. The control unit is configured to control the pump system, the z-drive, and the x-y-drive, to perform a droplet replacement procedure, and to initiate the droplet replacement procedure based on an initiation signal. The droplet replacement procedure includes: a) controlling the z-drive to increase the distance between the front lens and the sample to a first predefined distance in the z-direction; b) controlling the x-y-drive to position the front lens at a predefined distance in the x-y-directions away from an initial position; c) controlling the z-drive to reduce the distance between the front lens and the sample to a second predefined distance in the z-direction; d) controlling the pump system to create a new immersion droplet; and e) controlling the x-y-drive to position the front lens back at the initial position in the x-y-directions thereby pushing an old immersion droplet away from the initial position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a microscope comprising an immersion system according to an embodiment;

FIG. 2 is a schematic view of an immersion system according to an embodiment; and

FIGS. 3a to 3e are schematic views illustrating steps of a method for controlling an immersion system according to an embodiment.

### DETAILED DESCRIPTION

Embodiments of the present disclosure include an immersion system, a microscope, and a method for controlling an immersion system, which are capable of automatically dealing with immersion droplets containing air bubbles.

The immersion system of the present disclosure for a microscope comprises a reservoir for an immersion liquid, and a pump system, configured to move the immersion liquid from the reservoir to a target space between a front lens of an objective of the microscope and a sample arranged on a stage of the microscope to create an immersion droplet. The immersion system also comprises a z-drive, configured to move the objective and/or the stage along the z-direction in order to adjust the distance between the front lens and the sample in the z-direction, and an x-y-drive, configured to move the objective and/or the stage perpendicular to the z-direction in order to adjust the relative position of the front lens and the sample in the x-y-directions. The immersion system further comprises a control unit, configured to control the pump system, the z-drive, and the x-y-drive. The control unit is further configured to perform a droplet replacement procedure and to initiate the droplet replacement procedure based on an initiation signal. The droplet replacement procedure comprises at least the following steps: a) Controlling the z-drive to increase the distance between the front lens and the sample to a first predefined distance in the z-direction. b) Controlling the x-y-drive to position the front lens at a predefined distance in the x-y-directions away from an initial position. c) Controlling the z-drive to reduce the distance between the front lens and the sample to a second predefined distance in the z-direction. d) Controlling the pump system to create a new immersion droplet. e) Controlling the x-y-drive to position the front lens back at the initial position in the x-y-directions, thereby pushing an old immersion droplet away from the initial position.

The z-direction is parallel to the optical axis of the objective, while the x-y-directions are the directions perpendicular to the optical axis of the objective. The first predefined distance in the z-direction is greater than the first predefined distance in the z-direction. The pump system comprises a pump and tubing, for example. The immersion liquid may be water, oil, glycerol or other liquids conventionally used as immersion liquids.

It has been recognized that, when bubbles form in an immersion droplet, it is often not possible to remove the immersion droplet using the pump system, because the pump system may draw air, generating additional bubbles in the immersion liquid. Thus, the proposed immersion system of the present disclosure is capable of automatically replacing an immersion droplet with a new immersion droplet, without drawing the immersion liquid of the old immersion droplet back into the pump system, for example when the old immersion droplet comprises air bubbles causing blurring.

In order to replace the old immersion droplet, the immersion system first increases the distance between the front lens of the objective and the sample using the z-drive, for example by moving the objective away from the sample. This causes the old immersion droplet to tear away from the front lens, leaving it stuck to the sample. The immersion system then moves, for example, the objective lens sideways in order to move the front lens away from its initial position in the x-y-directions. Alternatively, the immersion system may also move the stage or both the objective and the stage to achieve the same effect. In the present disclosure, the initial position of the front lens in the x-y-directions is always understood as the position of the front lens relative to the sample in the x-y-directions before the objective and/or the stage were moved by the x-y-drive.

When the front lens is positioned at the predefined distance in the x-y-directions away from the initial position, the immersion system decreases the distance between the front lens of the objective and the sample using the z-drive, for example by moving the objective towards the sample, until the distance between the front lens and the sample is equal to the first predefined distance in the z-direction. The first predefined distance in the z-direction is preferably equal to an initial distance between the front lens and the sample before said distance was increased in step a) of the droplet replacement procedure. At this position away from the initial position the immersion system creates the new immersion droplet.

Then, the immersion system positions the front lens back at the initial position relative to the sample in the x-y-directions, but at the first predefined distance in the z-direction from the sample, for example by moving the objective back towards the initial position without increasing or decreasing the distance between the front lens and the sample. When the front lens is positioned back at the initial position, the distance between the front lens and the sample is not changed. When positioning the front lens back at its initial position, the new immersion droplet sticks the front lens, thereby pushing the old immersion droplet away and replacing it. Since the new immersion droplet is used to replace the old immersion droplet, no air can be accidentally drawn into the pump system. Thus, the immersion system is capable of automatically dealing with immersion droplets containing air bubbles.

In an embodiment, the control unit is configured to control the x-y-drive to move the objective and/or the stage such that a relative acceleration between the front lens and the sample does not exceed a predefined maximum acceleration during step e) of the droplet replacement procedure. For example, the predefined maximum acceleration may be within the range of 100 mm/s² and 200 mm/s². It has been recognized that limiting the maximum acceleration prevents the new immersion droplet from fusing with the old immersion droplet, thereby preventing the new immersion droplet from pushing the old immersion droplet away. Thus, limiting the maximum acceleration rather than the maximum speed ensures successful replacement of the old immersion droplet.

In an embodiment, the control unit is configured to generate the initiation signal based on image data generated by the microscope. For example, the control unit may be configured to analyze the image data generated by the microscope using known image processing methods to determine if air bubbles are present in the immersion droplet currently arranged in the target space. The control unit may be configured to automatically generate the initiation signal, if the control unit determines the presence of air bubbles based on the image data. Alternatively, or additionally, the control unit may be configured to control an output device to inform a user of the presence of air bubbles, so that the user may cause the initiation signal to be generated. The presence of air bubbles is determined automatically by the immersion system according to such an embodiment. This makes it easier even for a novice user to take full advantage of the immersion system.

In an embodiment, the immersion system comprises an overview camera arranged and configured to capture an image comprising at least the target space and to generate corresponding image data. The control unit is configured to generate the initiation signal based on image data generated by the overview camera. In such an embodiment, the control unit may be configured to analyze the image data generated by the overview camera using known image processing methods to determine if air bubbles are present in the immersion droplet currently arranged in the target space. In particular, the overview camera may have a lower magnification and higher focal length than the objective of the microscope, making it possible to more accurately determine the presence of air bubbles in the immersion droplet. Using the dedicated overview camera is particularly advantageous when the microscope uses microscopy methods other than light microscopy, for example fluorescence microscopy, which may make it very difficult to correctly determine the presence of air bubbles from the image data generated by the microscope itself. Like in the previous embodiment, the control unit may be configured to automatically generate the initiation signal, if the control unit determines the presence of air bubbles based on the image data, and/or to control the output device to inform the user of the presence of air bubbles. As the previous embodiment, an embodiment comprising the overview camera makes it easier for the novice user in particular to take full advantage of the immersion system.

In an embodiment, the immersion system comprises a moisture sensor arranged at the front lens. The control unit may be configured to generate the initiation signal based on a sensor signal generated by the moisture sensor. The moisture sensor may be a capacitive sensor or a resistive sensor, for example. The control unit may be configured to process the sensor signal to determine the presence of the immersion liquid in the target space or the lack thereof. For example, large air bubbles may be detected in this way. Once a large air bubble is detected, the control unit may automatically generate the initiation signal and/or control the output device to inform the user of the presence of air bubbles. The automatic detection of air bubbles makes it easier even for the novice user to use the immersion system to its fullest effect.

In an embodiment, the control unit is configured to generate the initiation signal based on a user input. For example, a user interface for controlling the microscope may comprise an element that enables the user to generate the user input, which causes the control unit to generate the initiation signal. This enables the user to initiate the droplet replacement procedure manually, for example when the user has determined that air bubbles are present in the currently used immersion droplet.

In an embodiment, the immersion system comprises an immersion cap. The immersion cap defines at least part of the target space and has an opening that is aligned with the front lens. The immersion cap is arranged or arrangeable at a front end of the objective, facing the sample. The immersion cap may be configured to be mountable to the objective, for example. In other embodiments, the immersion cap may be part of the objective. In some embodiments, the immersion cap may comprise the moisture sensor described above. The immersion cap provides a constant supply of the immersion liquid at the front lens, which makes it easier to use the immersion system with an inverted microscope.

According to another aspect, a microscope is provided. The microscope comprises the objective, the stage, and the immersion system as described herein. The microscope has the same advantages as the immersion system described herein. In particular, the microscope may be supplemented with the features described in the present disclosure in connection with the immersion system. Furthermore, the immersion system may be supplemented with the features described in the present disclosure in connection with the microscope.

According to yet another aspect, a method for controlling an immersion system of a microscope is provided. The method comprises at least the following steps: a) increasing the distance between a front lens of an objective of the microscope and a sample arranged on a stage of the microscope to a first predefined distance in the z-direction; b) positioning the front lens at a predefined distance in the x-y-directions away from an initial position; c) reducing the distance between the front lens and the sample to a second predefined distance in the z-direction; d) creating a new immersion droplet by depositing an immersion liquid at a target space between the front lens and the sample; and e) positioning the front lens back at the initial position in the x-y-directions, thereby pushing an old immersion droplet away from the initial position.

The method has the same advantages as the immersion system and the microscope described herein. In particular, the method may be supplemented with the features described in the present disclosure in connection with the immersion system or the microscope. Furthermore, the immersion system and the microscope may each be supplemented with the features described in the present disclosure in connection with the method.

In an embodiment, the method is initiated by a detection of air bubbles in an immersion droplet arranged in the target space. For example, the presence of air bubbles may be determined from image data generated by the microscope and/or an overview camera arranged and configured to capture an image comprising at least the target space. The automatic detection of air bubbles makes it easier for a novice user in particular to use the immersion system to its fullest potential.

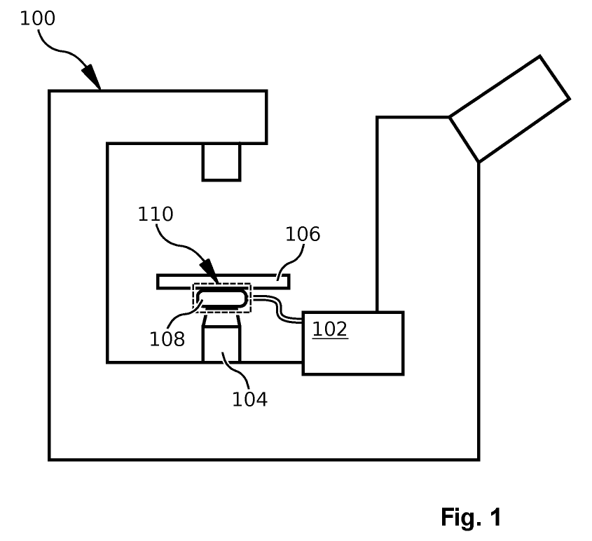

FIG. 1 is a schematic view of a microscope 100 comprising an immersion system 102 according to an embodiment.

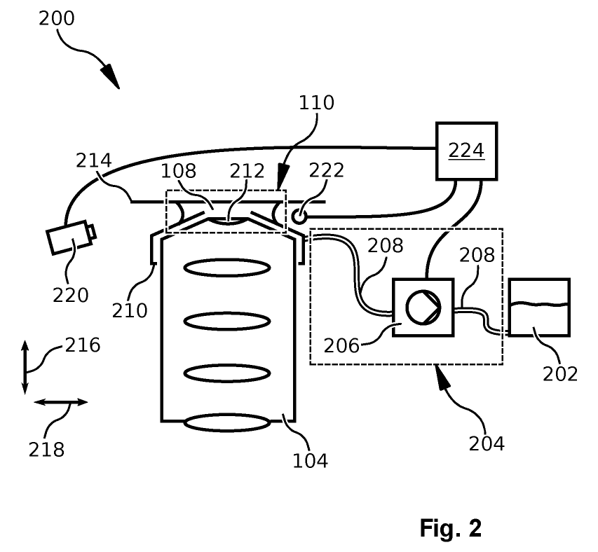

The microscope 100 is exemplary formed as an inverted microscope, having an objective 104 arranged below a stage 106. A sample 214 (c.f. FIG. 2), for example a specimen prepared on a microscope slide, is arranged on the stage 106. The stage 106 may be configured to be movable in the z-direction, i.e. along the optical axis of the objective 104, and in at least one direction perpendicular to the optical axis of the objective 104. Likewise, the objective 104 itself may be configured movable in the z-direction and in at least one direction perpendicular thereto.

The immersion system 102 is configured to create an immersion droplet 108 at a target space 110 located between a front lens 212 (c.f. FIG. 2) of the objective 104 and the sample 214. In FIG. 1 the target space 110 is exemplary located below the stage 106 and the sample 214. The immersion droplet 108 replaces air in the target space 110, reducing light refraction at the interface between the front lens 212 and the target space 110 as well as the sample 214 and the target space 110. This increases the effective numerical aperture of the objective 104. An exemplary embodiment of the immersion system 102 is described in more detail below with reference to FIG. 2.

FIG. 2 is a schematic view of an immersion system 200 according to an embodiment. The immersion system 200 may be used with the microscope 100 according to FIG. 1, for example. In the following the operation of the immersion system 200 is described with reference to the microscope 100 according to FIG. 1 by way of example only. The immersion system 200 is configured to automatically generate an immersion droplet 108 in the target space 110, and to replace an old immersion droplet with a new immersion droplet, for example when the old immersion droplet comprises air bubbles that would create blurring in an image generated by the microscope 100.

The immersion system 200 comprises a reservoir 202 for the immersion liquid, and a pump system 204 for moving the immersion liquid from the reservoir 202 to the target space 110 to create the immersion droplet 108. The pump system 204 comprises a pump 206, for example a peristaltic pump, and tubing 208. The pump system 204 may also be configured to remove immersion liquid from the target space 110 back to the reservoir 202, for example to remove the immersion droplet 108 from the target space 110. In the present embodiment, the immersion system 200 exemplary comprises an immersion cap 210 arranged at the at a front end of the objective 104. The immersion cap 210 has a conic shape adapted to the outer contour of the objective 104 and an opening aligned with the front lens 212 of the objective 104. The opening allows observation through the objective 104 when the immersion cap 210 is fitted to the objective 104. At least part of the target space 110 is formed by the immersion cap 210. The tubing 208 is connected to the immersion cap 210, to provide the immersion liquid to the target space 110.

A z-drive 216 of the immersion system 200 is configured to move the objective 104 and/or the stage 106 along the optical axis of the objective 104, i.e. the z-direction. By controlling the z-drive 216, the distance between the front lens 212 of the objective 104 and the sample 214 can be increased or decreased, for example by moving the objective 104 away from or towards the sample 214. An x-y-drive 218 of the immersion system 200 is configured to move the objective 104 and/or the stage 106 perpendicular to the optical axis of the objective 104, for example the x-direction and/or the y-direction. Using the x-y-drive 218, the positions of the sample 214 and/or the front lens 212 may be adjusted in the x-y-directions, i.e. the positions projected along the z-direction onto a plane perpendicular to the z-direction. In FIG. 2, the z-drive 216 is indicated by a first arrow, and the x-y-drive 218 by a second arrow.

In the present embodiment, the immersion system 200 also comprises an overview camera 220 directed at the target space 110, and a moisture sensor 222 arranged at the target space 110. The overview camera 220 may be used to capture an image of the immersion droplet 108 at the target space 110, for example in order to automatically determine if air bubbles are present in the immersion droplet 108. Likewise, sensor data from the moisture sensor 222 may be used to detect, in particular, large air bubbles in the immersion droplet 108.

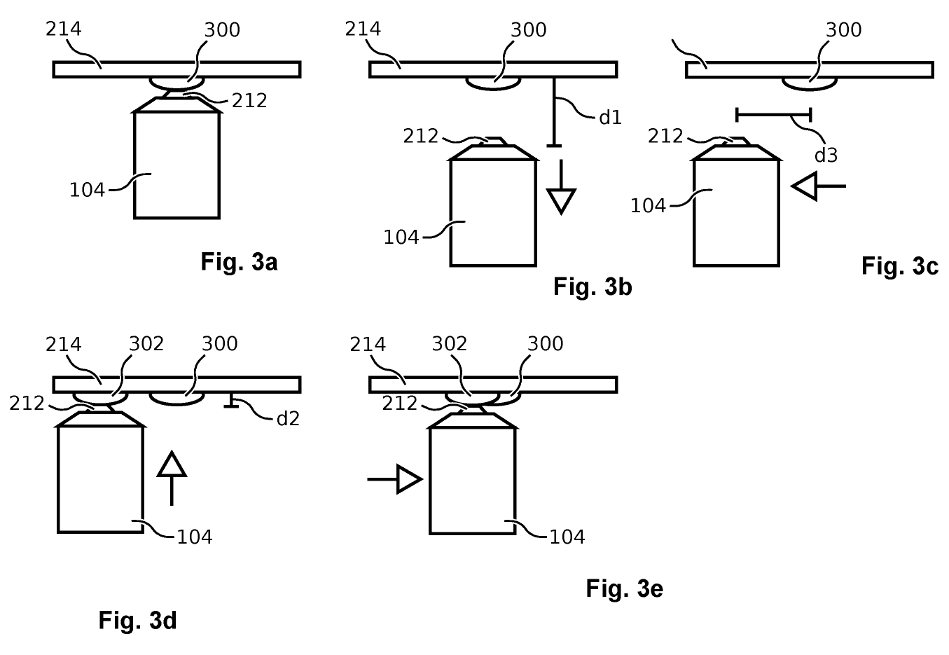

The immersion system 200 further comprises a control unit 224, which is configured to control the pump system 204, the z-drive 216, and the x-y-drive 218. In the present embodiment, the control unit 224 is also configured to receive and process image data generated by the microscope 100 and the overview camera 220 as well as to receive and process the sensor data generated by the moisture sensor 222. The control unit 224 is further configured to perform a droplet replacement procedure and to initiate the droplet replacement procedure based on an initiation signal. The droplet replacement procedure is described below with reference to FIGS. 3a to 3e and to a method for controlling the immersion system 200.

FIGS. 3a to 3e are schematic views illustrating steps of the method for controlling an immersion system 102, 200 according to an embodiment. The method replaces an old immersion droplet 300 arranged in the target space 110 with a new immersion droplet 302. The method may be performed using the immersion system 200 described above with reference to FIG. 2, for example. Any or all steps of the method may be performed as part of the droplet replacement procedure performed by the control unit 224 of the immersion system 200 described above. In the following, the method is described with reference to the immersion system 200 described above by way of example only.

FIG. 3a is a schematic view of the immersion system 200 in its initial state, i.e. before the method is initiated. The old immersion droplet 300 is arranged in the target space 110 between the front lens 212 and the sample 214, which is exemplary shown as a microscope slide, and contacts both the front lens 212 and an underside of the sample 214. The front lens 212 is at an initial position relative to the sample 214 in the x-direction and the y-direction (in the following shortened to x-y-directions), i.e. the directions perpendicular to the optical axis of the objective 104. The position of the front lens 212 in the x-y-directions may be determined by projecting the position of the front lens 212 along the z-direction, i.e. parallel to the optical axis of the objective 104, onto a plane perpendicular to the z-direction.

The method is initiated, for example, when air bubbles are detected in the old immersion droplet 300. The air bubbles may be detected by a user. The air bubbles may also be detected automatically by the control unit 224, for example. In some embodiments of the method, the air bubbles are detected based on image data, for example the image data provided by the overview camera 220 and/or the microscope 100. Known image processing methods may be used to identify the air bubbles in the old immersion droplet 300. The air bubbles may also be detected based on the sensor data from the moisture sensor 222. For example, it may be determined that a large air bubble is present in the old immersion droplet 300, when the immersion sensor detects less than the expected amount of the immersion liquid in the target space 110. The method may be initiated manually, for example via a user interface of the microscope 100, or automatically, for example by the control unit 224 generating the initiation signal. In an example, the initiation signal is generated based on the image data provided by the overview camera 220 and/or the microscope 100. In another example, the initiation signal is generated based on the sensor data provided by the moisture sensor 222.

FIG. 3b is a schematic view of the immersion system 200 illustrating a first step of the method. In the first step, the distance between the front lens 212 and the sample 214 is increased to a first predefined distance d1 in the z-direction. No sidewards movement occurs in this step. Therefore, the front lens 212 is still at its initial position relative to the sample 214 in the x-y-directions. In FIG. 3b, the objective 104 is moved down to increase the distance between the front lens 212 and the sample 214. Instead or as well, the sample 214 may be moved away from the objective 104 in other embodiments. The first step may be performed by the control unit 224 controlling the z-drive 216 of the immersion system 200. As can be seen in FIG. 3b, the old immersion droplet 300 remains at the underside of the sample 214 due to surface tension.

FIG. 3c is a schematic view of the immersion system 200 illustrating a second step of the method. In the second step, the front lens 212 is positioned at a predefined distance d3 in the x-y-directions away from its initial position. In FIG. 3c, the objective 104 is moved to the left to position the front lens 212. In other embodiments, the sample 214 or both the objective 104 and the sample 214 may be moved instead. The second step may be performed by the control unit 224 controlling the x-y-drive 218 of the immersion system 200.

FIG. 3d is a schematic view of the immersion system 200 illustrating both a third and a fourth step of the method. In the third step, the distance between the front lens 212 and the sample 214 is reduced to a second predefined distance db in the z-direction. The second predefined distance d2 in the z-direction may be equal to the distance between the front lens 212 and the sample 214 in the initial position shown in FIG. 3a. In FIG. 3d, the objective 104 is moved up to decrease the distance between the front lens 212 and the sample 214. Instead or as well, the sample 214 may be moved towards the objective 104 in other embodiments. The third step may be performed by the control unit 224 controlling the z-drive 216 of the immersion system 200.

In the fourth step, also illustrated by FIG. 3d, the new immersion droplet 302 is created by depositing the immersion liquid at the target space 110 between the front lens 212 and the sample 214. The new immersion droplet 302 is arranged in the target space 110 between the front lens 212 and the sample 214, and contacts both the front lens 212 and the underside of the sample 214. The fourth step may be performed by the control unit 224 controlling the pump system 204 of the immersion system 200.

FIG. 3e is a schematic view of the immersion system 200 illustrating a fifth and final step of the method. In the fifth step, the front lens 212 is positioned back at its initial position in the x-y-directions, i.e. the position shown in FIG. 3a. In FIG. 3e, the objective 104 is moved to the right to position the front lens 212. In other embodiments, the sample 214 or both the objective 104 and the sample 214 may be moved instead. Due to surface tension, the new immersion droplet 302 sticks to the front lens 212. Thus, the old immersion droplet 300 is pushed away from the initial position and replaced by the new immersion droplet 302. During the fifth step, the objective 104 and/or the sample 214 may be moved such that a predefined maximum relative acceleration is not exceeded. The fifth step may be performed by the control unit 224 controlling the x-y-drive 218 of the immersion system 200. The method is then ended when the front lens 212 is back at its initial position and the old immersion droplet 300 has been replaced by the new immersion droplet 302.

Identical or similarly acting elements are designated with the same reference signs in all Figures. As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

100 Microscope

102 Immersion system

104 Objective

106 Stage

108 Immersion droplet

110 Target space

200 Immersion system

202 Reservoir

204 Pump system

206 Pump

208 Tubing

210 Immersion cap

212 Front lens

214 Sample

216 z-drive

218 x-y-drive

220 Overview camera

222 Moisture sensor

224 Control unit

300, 302 Immersion droplet

d1, d2, d3 Distance

1. An immersion system for a microscope, comprising:
a reservoir for an immersion liquid;
a pump system configured to move the immersion liquid from the reservoir to a target space between a front lens of an objective of the microscope and a sample arranged on a stage of the microscope to create an immersion droplet;
a z-drive configured to move the objective and/or the stage along a z-direction in order to adjust a distance between the front lens and the sample in the z-direction;
an x-y-drive configured to move the objective and/or the stage perpendicular to the z-direction in order to adjust a relative position of the front lens and the sample in x-y-directions; and
a control unit configured to control the pump system, the z-drive, and the x-y-drive, wherein the control unit is further configured to perform a droplet replacement procedure and to initiate the droplet replacement procedure based on an initiation signal, the droplet replacement procedure comprising:
a) controlling the z-drive to increase the distance between the front lens and the sample to a first predefined distance in the z-direction;
b) controlling the x-y-drive to position the front lens at a predefined distance in the x-y-directions away from an initial position;
c) controlling the z-drive to reduce the distance between the front lens and the sample to a second predefined distance in the z-direction;
d) controlling the pump system to create a new immersion droplet; and
e) controlling the x-y-drive to position the front lens back at the initial position in the x-y-directions thereby pushing an old immersion droplet away from the initial position.

2. The immersion system according to claim 1, wherein the control unit is further configured to control the x-y-drive to move the objective and/or the stage such that a relative acceleration between the front lens and the sample does not exceed a predefined maximum acceleration during step e) of the droplet replacement procedure.

3. The immersion system according to claim 1, wherein the control unit is further configured to generate the initiation signal based on image data generated by the microscope.

4. The immersion system according to claim 1, further comprising an overview camera arranged and configured to capture an image comprising at least the target space and to generate corresponding image data, wherein the control unit is further configured to generate the initiation signal based on image data generated by the overview camera.

5. The immersion system according claim 1, further comprising a moisture sensor arranged at the front lens, wherein the control unit is further configured to generate the initiation signal based on a sensor signal generated by the moisture sensor.

6. The immersion system according to claim 1, wherein the control unit is further configured to generate the initiation signal based on a user input.

7. The immersion system according to claim 1, further comprising an immersion cap defining at least part of the target space and having an opening that is aligned with the front lens.

8. A microscope, comprising the objective, the stage, and the immersion system according to claim 1.

9. A method for controlling an immersion system of a microscope, the method comprising:
a) increasing a distance between a front lens of an objective of the microscope and a sample arranged on a stage of the microscope to a first predefined distance in a z-direction;
b) positioning the front lens at a predefined distance in x-y-directions away from an initial position;
c) reducing the distance between the front lens and the sample to a second predefined distance in the z-direction;
d) creating a new immersion droplet by depositing an immersion liquid at a target space between the front lens and the sample; and
e) positioning the front lens back at the initial position in the x-y-directions thereby pushing an old immersion droplet away from the initial position.

10. The method according to claim 9, wherein the method is initiated by a detection of air bubbles in an immersion droplet arranged in the target space.
